(19) United States
(12) Patent Application Publication
(10) Pub. No.: US 2019/0190967 A1
(43) Pub. Date: Jun. 20, 2019

(54) DATA DOWNLOAD VIA GROUP COLLABORATION

(71) Applicant: Nokia Technologies Oy, Espoo (FI)

(72) Inventors: Martin KOLLAR, Kosice (SK); Arkadiusz ZIEBA, Gdansk (PL); Hannu Petri HIETALAHTI, Kiviniemi (FI)

(73) Assignee: Nokia Technologies Oy, Espoo (FI)

(21) Appl. No.: 16/326,884

(22) PCT Filed: Aug. 26, 2016
(86) PCT No.: PCT/US2016/049039

§ 371 Date: Feb. 20, 2019

(51) Int. Cl. H04L 29/06

(52) U.S. Cl. CPC H04L 65/4015; H04W 84/12; H04L 65/1069; H04L 65/403

(57) ABSTRACT

Methods and apparatus, including computer program products, are provided for time aggregation. In some example embodiments, there may be provided a method that includes sending, by a user equipment, a request for data to be provided by the network by at least aggregating over time a download of the requested data to a group including at least one other user equipment; receiving, by the user equipment, a first portion of the requested data from the network; and receiving, by the user equipment, at least a second portion of the requested data from the group including the at least one other user equipment, when the user equipment and the group are at a location enabling transfer from the group to the user equipment via a lower-power radio technology. Related systems, methods, and articles of manufacture are also described.

### FIELD

The subject matter described herein relates to wireless systems.

### BACKGROUND

Radio technologies, such as LTE-Advanced and the like, may seek to increase data rates. For example, LTE-Advanced aims to support peak data rates of 1 Gigabit per seconds or more in the downlink to a user equipment and 500 Megabits per seconds or more in the uplink to the network. To fulfill these increased rates, increased transmission bandwidths, such as a transmission bandwidth of up to 100 MHz or more for example, may be needed. However in practice, the availability of such a relatively large portion of contiguous radio frequency spectrum may be difficult to find. As such, radio technologies, such as LTE-Advanced and/or other radio access technologies, may use carrier aggregation of multiple Component Carriers (CCs) to achieve a high-bandwidth transmission.

In the case of LTE-Advanced, it may support aggregation of up to five CCs, each having a 20 Megahertz bandwidth. From the perspective of layers higher than the radio layer, each CC may appear as a separate cell with its own cell identifier. A user equipment, such as a smart phone, cell phone, and/or other type of wireless device, may be configured for carrier aggregation, and when configured for carrier aggregation, the user equipment may connect to a Primary Serving Cell (PCell) and one or more Secondary Serving Cells (“SCells”).

### SUMMARY

Methods and apparatus, including computer program products, are provided for time aggregation.

In some example embodiments, there may be provided a method that includes sending, by a user equipment, a request for data to be provided by the network by at least aggregating over time a download of the requested data to a group including at least one other user equipment; receiving, by the user equipment, a first portion of the requested data from the network; and receiving, by the user equipment, at least a second portion of the requested data from the group including the at least one other user equipment, when the user equipment and the group are at a location enabling transfer from the group to the user equipment via a lower-power radio technology.

In some variations, one or more of the features disclosed herein including the following features can optionally be included in any feasible combination. The user equipment may include an application to generate the request. The user equipment may include an application configured to at least merge the first portion and the second portion to form the requested download. The group may be established to support a time aggregation download. The group may be selected via the user equipment and/or configured by the network. The request may include an indication that the download is to be provided by the network as a time aggregation download, wherein the time aggregation download is controlled by the network and causes the requested download to be sent as one or more portions over time to the group via a radio access network. The user equipment including an application may receive another portion of data including an identifier of another user equipment that is a member of the group, store, based on the identifier, the other portion of data, and initiate, by the application, a transfer of the other portion of the data to the other user equipment, when the user equipment and other user equipment are in proximity to enable a transfer via the lower-power radio technology transfer. The lower-power radio technology may include Bluetooth, WiFi, and/or WiFi Direct. The group may include the user equipment.

In some example embodiments, there may be provided a method that includes receiving, by a network node, a request for data to be provided to a target user equipment by at least aggregating over time a download of the requested data to a group including at least one other user equipment; causing, by the network node, a first portion of the requested data to be sent to the target user equipment; and causing, by the network node, at least a second portion of the requested data to be sent to the at least one other user equipment to enable the at least one other user equipment of the group to transfer the at least second portion to the target user equipment via a lower-power radio technology.

In some variations, one or more of the features disclosed herein including the following features can optionally be included in any feasible combination. There may be a determination, in response to the received request, whether the group including the at least one other user equipment has available capacity for the download on behalf of target user equipment. There may also be a selection, based on the determining, of the at least one other user equipment for receipt of the at least the at least second portion. The network node may select members of the group based on whether the members are in different cells. The network node may receive an indication of available storage at the group including the at least one other user equipment and enable, based on the determining, the at least second portion to be sent to the at least one other user equipment. The network node may include an application to add an identifier to the at least second portion to enable a corresponding application at the at least one other user equipment to determine whether the at least second portion should be transferred to the target user equipment. The group may be established to support a time aggregation download. The request may include an indication that the download is to be provided by the network as a time aggregation download, wherein the time aggregation download is controlled by the network and causes the requested download to be sent as one or more portions over time to the group via a radio access network. The lower-power radio technology may include Bluetooth, WiFi, and/or WiFi Direct. The group may include the target user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system for Time Aggregation, in accordance with some example embodiments;

FIG. 2 depicts an example of a proximity transfer to complete the data transfer, in accordance with some example embodiments;

FIG. 3 depicts examples of the core network node and user equipment configured to provide Time Aggregation, in accordance with some example embodiments;

FIG. 4 depicts examples of signaling diagrams for Time Aggregation, in accordance with some example embodiments;

FIG. 5 depicts another example of a signaling diagram for Time Aggregation, in accordance with some example embodiments; and

FIG. 6 depicts an example of an apparatus, in accordance with some example embodiments.

Like labels are used to refer to same or similar items in the drawings.

### DETAILED DESCRIPTION

As noted above, carrier aggregation may be a way to achieve high data rates. To that end, the network may further require the PCell and SCell(s) to overlap. However in practice, it may be difficult for a cellular network in real-world conditions to meet, at any given instance in time, rigorous carrier aggregation conditions such as the PCell-SCell coverage overlap, available resources at the SCell(s), and/or the like. Further, these rigorous conditions may result in cells with unused resources, when the SCell fails to satisfy these rigorous carrier aggregation establishment conditions.

In some example embodiments, there may be provided Time Aggregation (TA), which may aggregate a transfer of data over time and over one or more UEs, such as a download group of UE.

In some example embodiments, a target UE configured for TA may be a member of a download group (also referred to as “download for me group”). When this is the case, the target UE may request a download from the network, and this download may be provided by the network via cells and base stations to download group member UEs, in accordance with some example embodiments.

In some example embodiments, the request from the target UE may request a download of data, and the network may determine whether the data download to the target UE can be satisfied (for example, available resources at the download group, download type is not immediate and thus amenable to TA, and/or the like) as a TA download via the download for me group.

In some example embodiments, the request from the UE may explicitly request a TA download to the download for me group. When this is the case, the network may check the availability of the TA download service and check whether the download for me group has available resources for the TA download on behalf of the target UE.

In some example embodiments, the network, such as the Evolved Packet Core or network node therein, may determine the capacity and load at each of the corresponding cells serving the download group member UEs. Based on this determination, the network may, in accordance with some example embodiments, determine when and/or how much of the requested download for the target UE should be apportioned to each of the UEs in the download group for the first UE. The network may download in Time Aggregation a portion of the requested download to each of the UEs in the download group, and this download may be via radio access networks (for example, E-UTRAN and/or the like) between the UEs and for example corresponding base stations and cells. To complete the Time Aggregation download, the group members may transfer their portion of the download to the target UE, so that the target UE has the entire requested download. In some example embodiments, this transfer by the download for me group members may occur when the download group members are in proximity to each other. For example, the download group members UEs may transfer their portion of the TA download when the group members are all within Bluetooth, WiFi, and/or WiFi Direct range of each other. Thus in Time Aggregation, the network may provide via the cellular radio access network the TA download as an aggregate sent over time to a plurality of UEs, which may be members of a download for me group expected to later be in proximity to each other to complete the transfer to the target UE via for example another radio technology such as Bluetooth, WiFi, WiFi Direct, and/or the like.

To illustrate further, the target UE may request or need a large amount of data to be downloaded, but the downloaded data may not be needed at the target UE immediately, i.e., the download data can be provided later over a longer timeframe. For example, this target UE may request a large download of data for a background service, such as a software update for an application at the target UE. In some example embodiments, this target UE may be a member of a group, such as a “download for me” group of UEs. Members of the group can be family members, company members, and/or any other type of group, and this group may include UEs, which will likely be at a location at which the group members can use another radio technology, such as WiFi, WiFi Direct, Bluetooth, and/or other shorter range (when compared to the cellular radio access network between the base station and UE) and/or lower power radio technology (when compared to the cellular radio access network between the base station and UE). To initiate the Time Aggregation data download to the target UE, the network, such as the Evolved Packet Core (EPC), may verify the availability of the remaining members of the group, and if the capacity and load conditions in the corresponding cells of the group members can be met, then the EPC may allocate resources for the download to the other UEs in the group. Later, when the group members are within the proximity of each other (enabling for example use of shorter range and/or lower power links, such as WiFi, WiFi Direct, Bluetooth, and/or the like), the group members may transfer the data to the target UE to complete the Time Aggregation transfer.

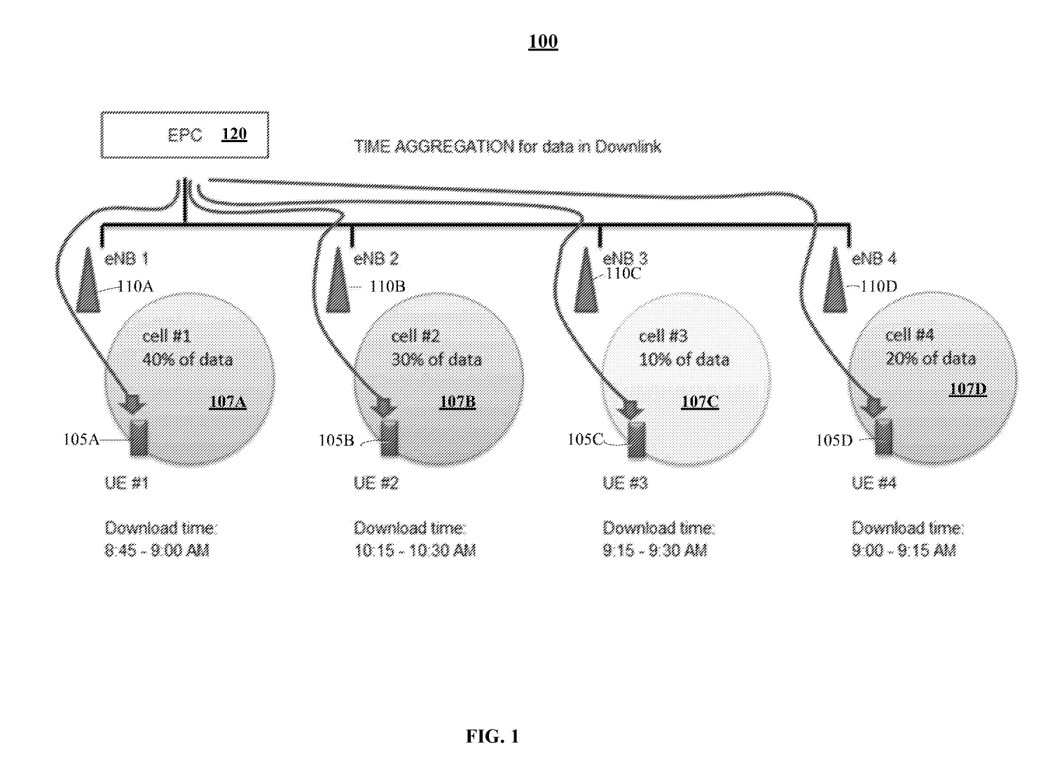

FIG. 1 depicts an example of a system 100, in accordance with some example embodiments.

The system 100 may include one or more UEs 105A-D (labeled UE#1 to UE#4), each of which may be served via a cell 107A-D and a corresponding base station 110A-D. Base stations 110A-D may couple to a core network, such as an Evolved Packet Core (EPC) 120. The base stations may be implemented as evolved Node B (eNB) type base stations, although other types of base stations under the control of a core network may be implemented as well. Moreover, the cells may be implemented as E-UTRAN cells, although other types of cells may be implemented as well.

The UEs 105A-D may be configured to be part of a group for purposes of a Time Aggregation (TA) download, in accordance with some example embodiments. Suppose for example, the target UE 105A (labeled UE#1) requests or needs a large amount of data to be downloaded. The target UE 105A may request the large data download and/or request that the download should be performed as a TA download to the download group 105A-D, in accordance with some example embodiments.

The EPC 120 may check whether the group member cells 107A-D (which are used by group members UE 105A-D) each have sufficient capacity and the current load enable carrying a portion of the data download requested by the target UE 105A. If the capacity and load indicate that a cell can carry a portion of the data download for target UE 105A, the EPC 120 may decide to use the available resources at a corresponding cell 107A-D to download a portion of the data download intended for the target UE 105A. Alternatively or additionally, the EPC may also check other conditions such as checking that cells 107B-D are different from cell 105A of the target UE 105A. For example, in some example embodiments, the EPC may decide to use available resources at the corresponding cells 107A-D when the cells are different from the first cell 107A. Alternatively or additionally, the EPC may also as a condition before selecting a UE whether there is sufficient memory to store the download (for example, the EPC may query the UEs 105A-D).

Because the EPC 120 can obtain or has information regarding the capacity and/or load at each cell, the EPC can determine whether a given cell can handle carrying a portion of the download for the target UE 105A. Moreover, the EPC 120 can select the portion of data volume to each cell over time. In the example of FIG. 1, UE 105A may be allocated, by the EPC 120, a 40% portion of the big data download requested by UE 105A; UE 105B may be allocated, by the EPC 120, a 30% portion of the big data download requested by UE 105A; UE 105C may be allocated, by the EPC 120, a 10% portion of the big data download requested by UE 105A; and UE 105D may be allocated, by the EPC 120, a 20% portion of the big data download requested by UE 105A (although the allocation amounts in this example are merely examples so other amounts including zero may be used as well).

Moreover, the EPC 120 may select, based on the capacity and expected load at each cell, a time for each of the downloads. In the example of FIG. 1, the download to UE 105A may occur at a first time (8:45 AM to 9 AM), the download to UE 105B at a second time (10:15 AM to 10:30 AM), the download to UE 105C at a third time (9:15 AM to 9:30 AM), and the download to UE 105D at a fourth time (9:00 AM to 9:15 AM), although the times in this example are merely examples so other times may be used as well. Moreover, although the download times are different in the example of FIG. 1, some of the download times may be the same or overlap as well. Thus, the EPC selects a portion of data volume for transmission to each cell over time, so the data downloads do not need to occur at the same time frame.

After the data is downloaded to the group members via the corresponding cells and base stations, the UEs 105A-D may be at a location at which the UEs 105A-D can use another radio technology to complete the transfer to the target UE 105A. This other radio technology may be a lower power and/or shorter-range radio technology, when compared to the E-UTRAN. Examples of the other radio technologies may include WiFi, WiFi Direct, Bluetooth, Bluetooth Low Energy, and/or other lower power and/or shorter ranger radio technologies. To illustrate further, when UEs 105A-D are at a common location, such as a home, office building, room, and/or the like and within WiFi or Bluetooth range, the UE 105B may send the 30% portion to UE 105A via a Bluetooth or WiFi Direct connection or link; UE 105C may send the 10% portion to UE 105A via a Bluetooth or WiFi Direct connection or link; and UE 105D may send the 20% portion to UE 105A via a Bluetooth or WiFi Direct connection or link.

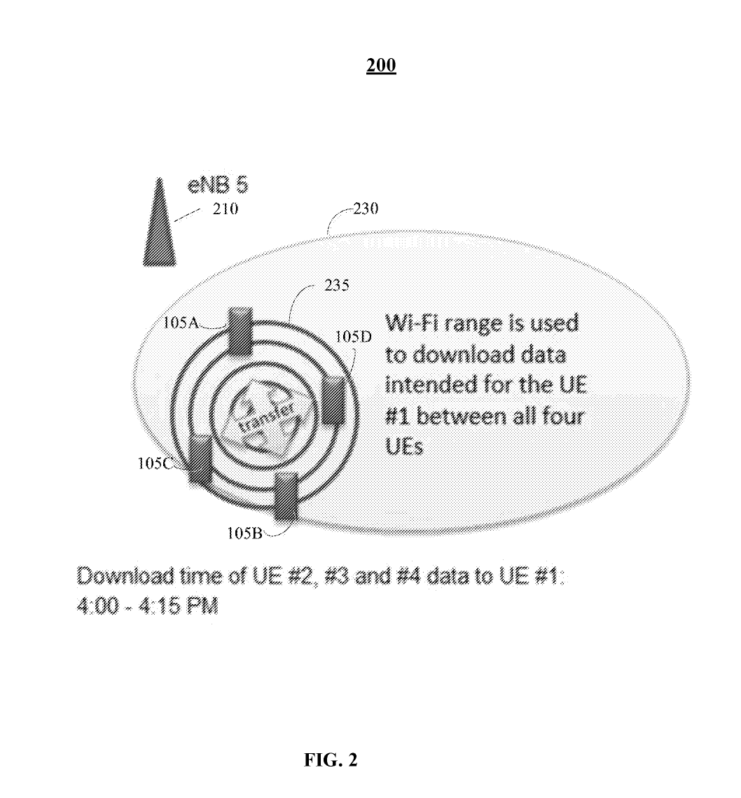

FIG. 2 depicts UEs 105A-D transferring the noted portion to UE 105A via WiFi 235, although other radio technologies may be used as well. In the example of FIG. 2, UE 105B may send the 30% portion to UE 105A via a WiFi Direct link; UE 105C may send the 10% portion to UE 105A via a WiFi Direct or link; and UE 105D may send the 20% portion to UE 105A via a WiFi Direct link. FIG. 2 also illustrates that the transfer may take place at a later time (for example, later that day at 4:00-4:15 PM, although the transfer may occur at any other time as well). The UE group members 105A-D may be covered by another cell or base station 210 as shown at FIG. 2, although one of the serving base stations depicted at FIG. 1 may also cover the transfer. However, during the data transfer among UEs 105A-D, the UEs do not need to be coupled to a serving base station as the transfer may use a radio technology different from the cellular radio access technology provided by the serving base station 210.

In some example embodiments, the UEs 105A-D may detect that they are in proximity of each other and may trigger the device-to-device transfers of data at FIG. 2. In some example embodiments, the network may detect that the UEs 105A-D are in proximity of each other and may trigger the transfers at FIG. 2 (for example, by sending a message to one or more of the UEs to start the transfer to the target UE 105A).

Although FIG. 2 shows all of the devices being within proximity of each other at the same time in order to trigger the transfer to the target UE 105A, the transfer may be triggered whenever a group member is within the proximity of the target UE 105A that is waiting for the TA download data. For example, UE 105B may be in WiFi range of UE 105A at 2 PM, in which case UE 105B may trigger the data transfer to UE 105A, while UEs 105C-D transfer their data to UE 105A later in the day when they are in range of UE 105A.

Although FIG. 1 depicts the TA download occurring for the network, such as EPC, of a single cellular operator, the TA may be provided over the networks/EPC of different cellular operators as well.

In some example embodiments, a service, such as an application, may be created at the network side and the UE side. For example, the network, such as the EPC 120, may configure or create the download group for a UE. To illustrate further, the UE 105A may request via a service or application that the network create a download for me group, such as the group comprising 105A-D to enable the group members 105B-D to download data on behalf of target UE 105A. In some example embodiments, a given UE may be a member of more than one download group. Moreover, the download group members may all participate in the TA downloads using the other group members. For example, although some of the examples refer to target UE 105A as the requesting TA download entity, the other UEs may also be target UEs participating in TA downloads as well.

When the target UE 105A requests a download that can be handled via the download group (for example, a request for a relatively big amount of data, related to background services and/or any other type of download that can be satisfied over a relatively longer period of time), the network may check whether the UE 105A belongs to a download group (also referred to herein as “download for me group”). If so, the network may also check, for each member of the download group associated with UE 105A, the corresponding cell capacity and load (and/or as noted above whether the group members cells are different). In the case of each UE being in a different cell, the network may apportion a data volume assignment to each group member UE based on the determined capacity and load (for example, according to the available or free capacity in each cell the UEs are camping in). This apportionment may also include a schedule (or time, for example) when each group member UE should perform its download. In some example embodiments, the data that is downloaded may be data that is not time sensitive, such as background services, services that do not create a user interface, offline- movie downloads, offline- software downloads, and/or other non-time sensitive downloads.

When a UE becomes a member of a download group, the network may send to each UE group member the identity of each of the group members, and the identity may be sent to each UE via a message, such as a network access stratum (NAS) message (which may help ensure that the application or service knows the download group as well). The NAS message may also trigger activation of the service or application at the UE side. The identity of the UE may be implemented in a variety of ways including using a phone number, an IMSI, a subscriber number, an identifier indicating the UEs download for me group (or groups), and/or any other type of identifier identifying a UE. The activated service/application may then be responsible for handling, at the UE, TA including data transfer between the UEs via WiFi Direct, Bluetooth, and/or the like.

In some example embodiments, a UE in the download group may need to recognize whether data received from the network is for the UE or for another group member UE. To that end, the network may implement, in accordance with some example embodiments, a service or application, such as a TA application, to enable the TA downloads. For example, the network side TA application may form or control the download for me groups, may determine and/or allocate the resources for TA downloads (or portions thereof) to each of the download for me group member UEs, may queue or hold awaiting transmission to the download for me group member UEs, may initiate transmission of the TA downloads (or portions thereof) to the download for me group member UEs, and/or may track the progress of the TA downloads (for example, by receiving acknowledgments by the download for me group members).

The UE side TA application may read the identifiers in the data received by the EPC to determine whether the data is for that UE or for another UE that is waiting for its data as part of a TA download. This data for another UE may be placed in a bin, container, or queue for the other UE until the proximity transfer via WiFi, WiFi Direct, and/or Bluetooth can take place. For example, UE 105B may have a service, such as a TA application, that receives the network provided TA data. The TA application may read an identifier associated with the received data, and place, based on the identifier, the data in a corresponding queue, container, or bin assigned to for example the target UE 105A (which in this example is the UE waiting for the TA data). When UE 105B and 105A are in proximity to one another as described in the example of FIG. 2, the TA application at UE 105B may transfer the data in the queue, container, or bin to UE 105A in order to complete the transfer. In this example, at the S1 interface level, there is no differentiation regarding which data are for the UE 105B or which data are for the other UEs from the download group. The differentiation occurs, however, at the TA application which can differentiate based on the identifiers on the data, which data is for the UE 105B and which data is for another UE such as the target UE 105A. The TA application may also ensure the data are transferred via WiFi Direct for example to the target UE 105A, and the TA application at UE 105A may also merge and/or rearrange data chunks received from each of the other UEs 105B-D that are providing data as part of the TA download group.

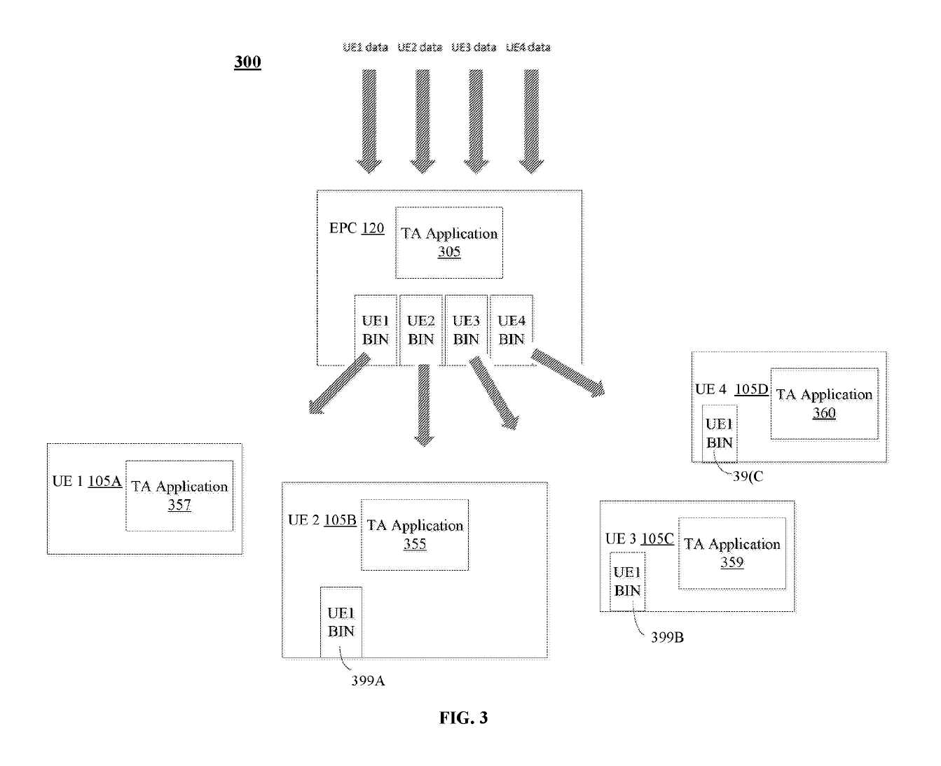

FIG. 3 depicts an example of a system 300, in accordance with some example embodiments. FIG. 3 includes UEs 105A-D, each of which may include a UE side service or application, such as TA applications 355-360. The system 300 may also include a core network, such as EPC 120. At EPC 120, there may also be implemented a network side service, such as TA application 305.

The TA application 305 may be configured to receive requests for downloads from a UE, configure the download for me group, determine whether a given UE download member can receive a portion of the download, trigger the TA data downloads to each of the download for me UE group members, and/or confirm that downloads are received at each of the UE group members and, after the transfer to a target UE such as target UE 105A for example, that the transfer is complete.

The TA application 305 may also add identifiers to data received for each of the group member UEs. The identifiers may allow the TA applications at the UEs to determine whether a received packet is for the receiving UE or another UE in the download for me group. For example, TA application 305 may download data to UE 105B via a queue or bin for that UE 105B. Some of the data may be for UE 105B but some of the data may be TA download data for a target UE such as target UE 105A. As such, the TA application 305 may add identifiers to the data to identify the destination UE. In this example, when UE 105B receives data, the TA application 355 may parse the received packets based on the identifiers added by TA application 305. For example, TA application 355 may parse packets for UE 105A into a queue, bin, or container 399A for UE 105A, while packets for UE 105B may be kept for use at UE 105B itself. As noted, when UE 105A and UE 105B are in WiFi or Bluetooth proximity of each other, the TA application 355 may trigger sending the data in bin 399A to the target UE 105A. If other TA applications 359-360 are also in proximity, these TA applications 355 may also trigger sending the data in their bins 399B-C bin to the target UE such as target UE 105A. The TA application 357 may merge (for example, arrange the data chunks in their proper order) the data chunks sent by each of the group members UE105B-D. The TA application 357 may also send acknowledgement messages to the UE group members UE 105 B-D to indicate a successful transfer of the TA download data. The TA application 357 may also send acknowledgement messages to EPC 120 to indicate a successful transfer of the TA download data.

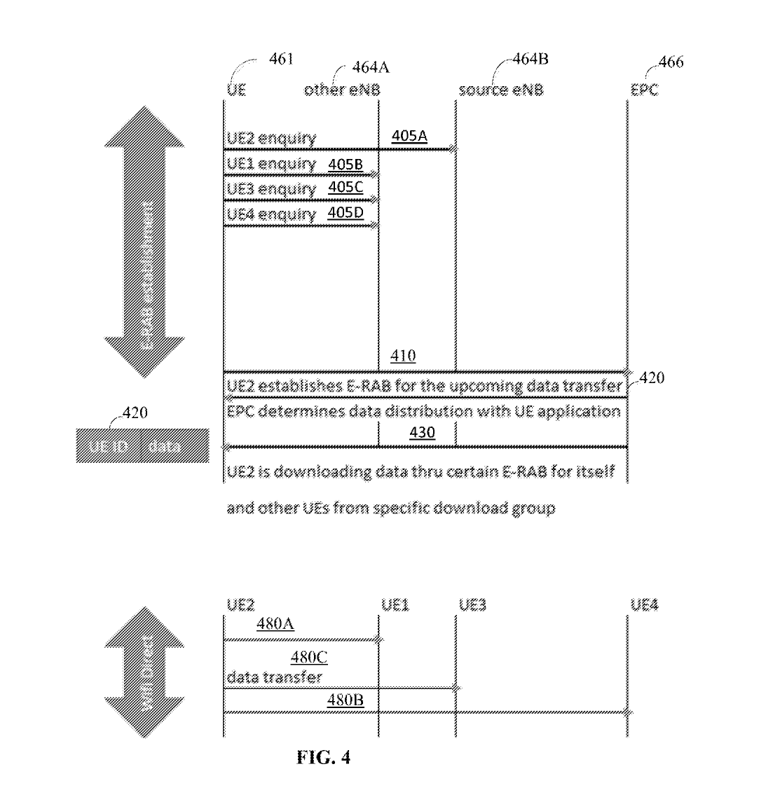

FIG. 4 shows at 405A-D each of the UEs 105A-D initiating the setup of radio bearers, such as E-RABs, from the UEs 462 (for example, UEs 105A-D), via their corresponding base stations 464A-B (for example, base station 110A-D) to the EPC 466 (for example, EPC 120), in accordance with some example embodiments. The E-RAB may uniquely identify the concatenation of an S1 Bearer (which is between a base station and a node in the EPC such as a mobility management entity or other anchor node) and the corresponding Data Radio Bearer (which is between a base station and the UE).

At 410, the E-RAB from UE 105B to a node in the EPC 120 may be established to enable the TA download (or portion thereof) to UE 105B, in accordance with some example embodiments. At 420, the EPC 120 may determine, based on the capacity and load associated with UE 105B, an allocation or portion of the TA download to allocate to the UE 105B on behalf of the target UE 105A for example. The EPC 120 may determine, based on the capacity and load associated with UE 105B, an allocation or portion of the TA download to allocate to the other group members as well.

At 430, the UE 105B may receive, via the established E-RAB, data for UE 105B as well as data for other UEs which may be part of the download for me group. For example, UE 105B may receive the 30% portion described above with respect to FIG. 1 downloaded on behalf of the target UE 105A as part of a TA download.

At 430, the UE 105B may also receive TA download data for other UEs in the group (or for other groups UE 105B may be a member of). For example, UE 105B may receive a portion of a TA download on behalf of another target UE 105C or 105D for example. When this is the case, UE 105B may store, in a bin for example, the data for UE 105C or 105DA until a proximity-based transfer may occur over WiFi, WiFi Direct, Bluetooth, and/or the like can occur. FIG. 4 also shows at 480A-C UEs 105A-D being in range, such as WiFi, Bluetooth, or WiFi Direct range, and then transferring the TA downloaded data to the target UE 105A.

The data download to UE 105B may include at least identifier 466, which may be added by TA application 305. The identifier, as noted, allows a corresponding TA application 355 at UE 105B for example to parse whether the received downloaded data is for UE 105B or another UE, such as the target UE 105A or other UE download group member for example.

In some example embodiments, the EPC may determine whether the UEs are stationary or not to assess the possibility of the UE moving to another, highly loaded cell before the TA download. In some example embodiments, the EPC may allow download to the download for me group member UEs when the UEs are in cells having a low load (for example, a load below a predetermined threshold load).

In some example embodiments, the EPC may determine which download for me group members are allocated a portion of the TA download based on available storage at the UE. For example, TA application 360 may signal to the EPC 120 that it has no available memory, in which case EPC 120 may decide to not use UE 105D as a download for me group member (at least until memory becomes available again. Alternatively or additionally, TA application 360 may signal to the EPC 120 that it has a certain amount of available memory, in which case EPC 120 may apportion so that it does not exceed the amount of available memory at UE 105D.

In some example embodiments, if a download for me group member does not complete the TA data proximity transfer via WiFi or Bluetooth to the target UE as described above at for example FIGS. 2 and 480, the EPC may wait for a predetermined time and if the download for me group member fails to complete the transfer, the EPC may download the missing data portion via another download for me group member (including the target UE) to enable the proximity transfer. In some example embodiments, a target UE such as UE 105A, may send a request (for example, after waiting a predetermined time for the portion of the TA download) to the EPC that a portion was not received or requires retransmission, so that the EPC can schedule the missing download to a download for me group member (including the target UE). In some example embodiments, the download for me group members may signal to each other or the EPC if a low power or battery condition exists. For example, if UE 105C loses power and does not transfer its portion, the EPC 120 may retransmit the UE105C portion as noted above.

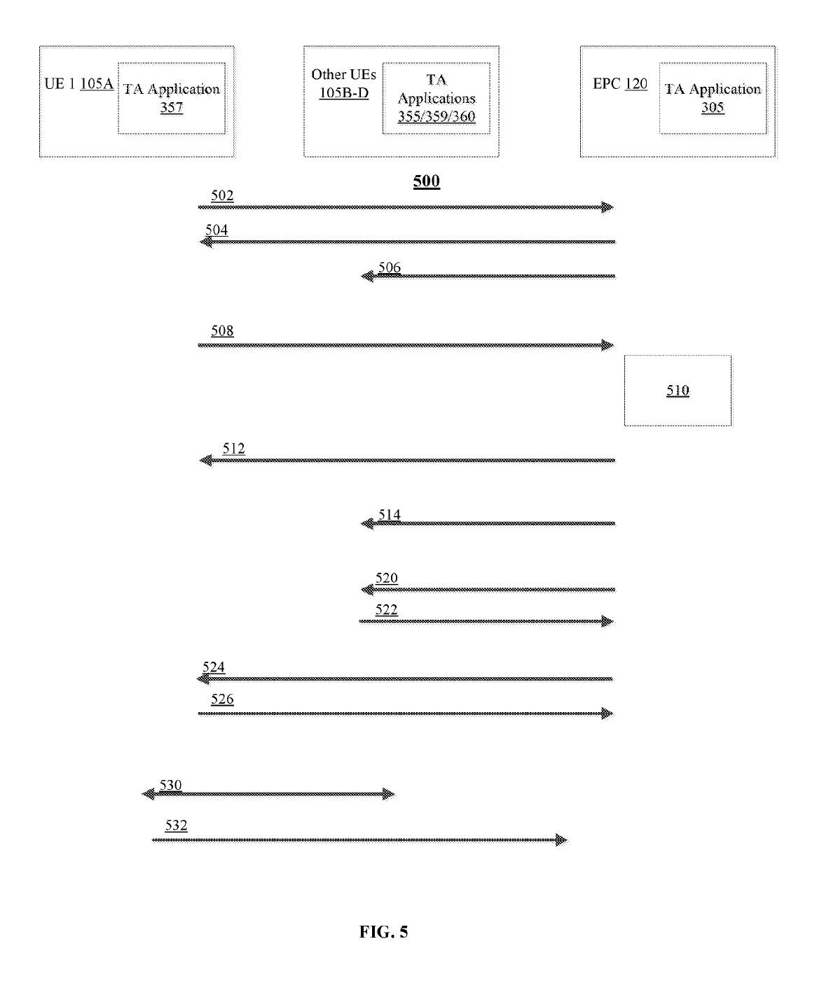

FIG. 5 depicts an example of a process 500 for TA, in accordance with some example embodiments. The process 500 depicts a target UE, such as UE 105A including TA application 357, the other UEs of the download group such as UEs 105B-D including corresponding TA applications 355, 359, and 360, and the process further depicts the EPC 120.

At 502, the target UE 105A including the TA application 357 may send a request to form a download group for purposes of TA downloads, in accordance with some example embodiments. The message sent at 502 may include a proposed list of group members, such as UEs 105B-D, although the group may be proposed by the network as well.

At 504, the EPC 102 may acknowledge the request sent at 502, in accordance with some example embodiments. The acknowledgement may include the identity of the download group members. At 506, the EPC may also send an indication to the group members, such as UEs 105B-D indicating the identity of the other download group members, in accordance with some example embodiments.

At 508, the target UE 105A may send a message indicative of a request to download data, in accordance with some example embodiments. This message sent at 508 may explicitly indicate that the request is for a TA download. Alternatively or additionally, the message sent at 508 may generally request a data download, and the network such as EPC 120 may evaluate whether it is a good candidate for the TA download.

At 510, the network such as EPC 120 may determine whether the download group members UEs 105A-D have available capacity to download, on behalf of UE 105A, the requested data download, in accordance with some example embodiments. The EPC 120 may also determine whether the cells serving the download group UEs 105A-D are the same or different. In some example embodiments, the EPC 120 may allocate a portion of the download to each of the download group UEs 105A-D that has available capacity to download the requested data. If however, a given UE does not have the capacity, the EPC may not allocate a portion of the download to that UE. Alternatively or additionally, the EPC may perform the portion allocation to the download group UEs 105A-D that resides in different cells. For example, if UEs 105C-D are camped on the same cell, the EPC may allocate a portion to UE 105C but not UE 105D (alternatively, the EPC may allocate smaller portions to each UE 105C and D while keeping below the shared cells available capacity constraint). Alternatively or additionally, the EPC may select when the download should occur to each of the download group UEs 105A-D (for example, the actual scheduling and resource allocation may be performed at the radio access network or base station level).

At 512, the network such as EPC 120 may acknowledge the request sent at 508, in accordance with some example embodiments. The acknowledgement may include an indication of the identity of the download group member UEs 105A-D that have been allocated a portion of the requested TA download. For example, the acknowledgement may indicate the identity of the group members and what portions of the download they have been allocated. Alternatively or additionally, the acknowledgement may include the schedule, such as when the download will occur at each of the download group UEs 105A-D.

At 514, the network such as EPC 120 may send an indication to each of the other download group UEs 105B-D indicating the identity of the download group UEs 105A-D that have been allocated a portion of the requested TA download. Alternatively or additionally, the indication sent at 514 may include the schedule, such as when the download will occur at each of the download group UEs 105A-D.

At 520, the network such as EPC 120 may download a portion of the TA download to the other download group member UEs 105B-D, in accordance with some example embodiments. In response, the other UEs 105B-D may acknowledge successful download at 522, in accordance with some example embodiments. At 524, the network such as EPC 120 may download a portion of the TA download to the target UE 105A, in accordance with some example embodiments. In response to a successful download, the target UE 105A may send acknowledge(s) at 526, in accordance with some example embodiments.

At 530, the other UEs 105B-D may be in the proximity of UE 105A, and, as such, trigger the transfer from each of the other UEs 105B-D to the target UE 105A, in accordance with some example embodiments. For example, when the other UEs 105B-D are in WiFi or Bluetooth range of UE 105A, the TA applications at each of the UEs may initiate the transfer to the target UE 105A via WiFi, Bluetooth, and/or other shorter range and/or lower power radio technology (when compared to the radio access technologies at the serving UTRAN cells). As noted above, the target UE 105A including the TA application may re-arrange the data portions received from each of the UEs 105B-D. At 532, the target UE 105A may send an acknowledgement when the TA download requested at 508 is successfully received, in accordance with some example embodiments.

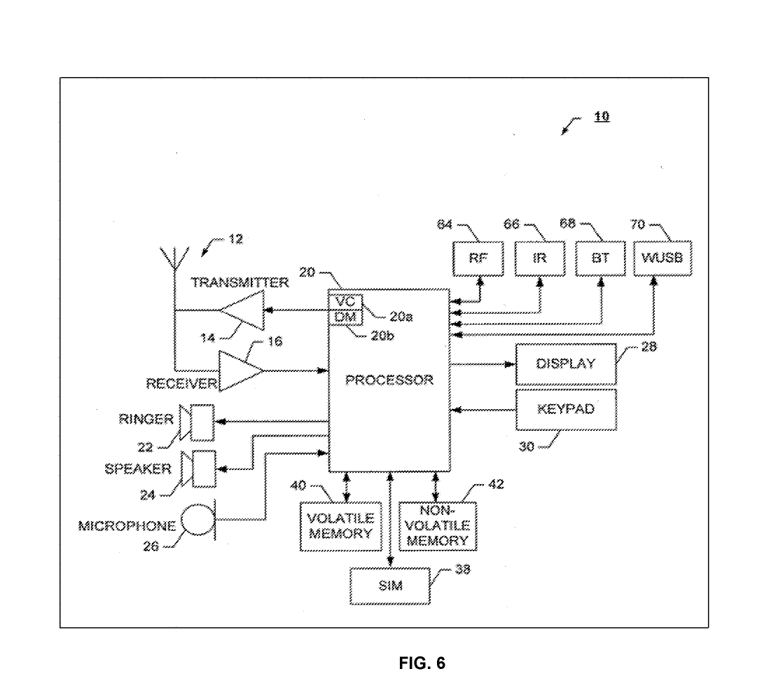

FIG. 6 illustrates a block diagram of an apparatus 10, in accordance with some example embodiments. The apparatus 10 (or portions thereof) may be configured to provide a radio, such as user equipment (for example, user equipment 105A-D). In some example embodiments, the apparatus may include a TA application or service to provide the TA download described here. Moreover, the apparatus 10 (or portions thereof) may be configured to provide a base station (for example, base station 110A-D). The apparatus may be implemented as any device including a wireless device, a smart phone, a cell phone, a machine type communication device, a wireless sensor, a radio relay, an access point, and/or any other radio including a processor and memory based device.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 6 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 6, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein with respect to a user equipment and/or a base station. The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein with respect to the user equipment and/or a base station (see, for example, process 500 and/or the like as disclosed herein).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 6, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is enhanced resource utilization to support data transfers.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-46. (canceled)

47. A method comprising:
sending, by a user equipment, a request for data to be provided by a network by at least aggregating over time a download of the requested data to a group including at least one other user equipment;
receiving, by the user equipment, a first portion of the requested data from the network; and
receiving, by the user equipment, at least a second portion of the requested data from the group including the at least one other user equipment, when the user equipment and the group are at a location enabling transfer from the group to the user equipment via a lower-power radio technology.

48. The method of claim 47, wherein the user equipment includes an application configured to at least merge the first portion and the second portion to form the requested download.

49. The method of claim 47, wherein the group is established to support a time aggregation download.

50. The method of claim 47, wherein the request includes an indication that the download is to be provided by the network as a time aggregation download, wherein the time aggregation download is controlled by the network and causes the requested download to be sent as one or more portions over time to the group via a radio access network.

51. The method of claim 47, further comprising:
receiving, by the user equipment including an application, another portion of data including an identifier of another user equipment that is a member of the group;
storing, based on the identifier, the other portion of data; and
initiating, by the application, a transfer of the other portion of the data to the other user equipment, when the user equipment and other user equipment are in proximity to enable a transfer via the lower-power radio technology transfer.

52. The method of claim 47, wherein the lower-power radio technology comprises Bluetooth, WiFi, and/or WiFi Direct.

53. The method of claim 47, wherein the group includes the user equipment.

54. An apparatus comprising:
at least one processor; and
at least one memory including computer program code, the at least one memory and computer program code configured to, with the at least one processor, cause the apparatus to at least:
send a request for data to be provided by a network by at least aggregating over time a download of the requested data to a group including at least one other apparatus;
receive a first portion of the requested data from the network; and
receive at least a second portion of the requested data from the group including the at least one other apparatus, when the apparatus and the group are at a location enabling transfer from the group to the apparatus via a lower-power radio technology.

55. The apparatus of claim 54, wherein the apparatus includes an application configured to at least merge the first portion and the second portion to form the requested download.

56. The apparatus of claim 54, wherein the group is established to support a time aggregation download.

57. The apparatus of claim 54, wherein the group is selected via the apparatus and/or configured by the network.

58. The apparatus of claim 54, wherein the request includes an indication that the download is to be provided by the network as a time aggregation download, wherein the time aggregation download is controlled by the network and causes the requested download to be sent as one or more portions over time to the group via a radio access network.

59. The apparatus of claim 54, wherein the apparatus is further configured to at least:
receive, by the apparatus including an application, another portion of data including an identifier of another apparatus that is a member of the group;
store, based on the identifier, the other portion of data; and
initiate, by the application, a transfer of the other portion of the data to the other apparatus, when the apparatus and other apparatus are in proximity to enable a transfer via the lower-power radio technology transfer.

60. The apparatus of claim 54, wherein the lower-power radio technology comprises Bluetooth, WiFi, and/or WiFi Direct.

61. The apparatus of claim 54, wherein the group includes the apparatus.

62. The apparatus of claim 54, wherein the apparatus and the at least one other apparatus each comprise a user equipment.

63. An apparatus comprising:
at least one processor; and
at least one memory including computer program code, the at least one memory and computer program code configured to, with the at least one processor, cause the apparatus to at least:
receive a request for data to be provided to a target user equipment by at least aggregating over time a download of the requested data to a group including at least one other user equipment;
cause a first portion of the requested data to be sent to the target user equipment; and
cause at least a second portion of the requested data to be sent to the at least one other user equipment to enable the at least one other user equipment of the group to transfer the at least second portion to the target user equipment via a lower-power radio technology.

64. The apparatus of claim 63, wherein the apparatus is further configured to at least:
determine, in response to the received request, whether the group including the at least one other user equipment has available capacity for the download on behalf of target user equipment; and
select, based on the determining, the at least one other user equipment for receipt of the at least the at least second portion.

65. The apparatus of claim 63, wherein the apparatus includes an application to add an identifier to the at least second portion to enable a corresponding application at the at least one other user equipment to determine whether the at least second portion should be transferred to the target user equipment.

66. The apparatus of claim 63, wherein the apparatus comprises a network node.
